(19) United States
(12) Patent Application Publication
(10) Pub. No.: US 2022/0142069 A1
(43) Pub. Date: May 12, 2022

(54) IRRIGATION APPARATUS AND FEEDING SYSTEM

(71) Applicant: 4D Holding, LLC, Studio City, CA (US)

(72) Inventor: Aaron Marshall, Studio City, CA (US)

(21) Appl. No.: 17/562,895

(22) Filed: Dec. 27, 2021

Related U.S. Application Data
(63) Continuation-in-part of application No. 17/096,669, filed on Nov. 12, 2020.

(51) Int. Cl. A01G 27/02

(52) U.S. Cl. CPC A01G 27/02

(57) ABSTRACT

An irrigation apparatus for dispersing liquid through a plant growing medium is disclosed. The apparatus includes a container. The container has an outer wall with an inner surface, an open top, and a base portion configured to cover the plant growing medium. The base portion is configured with a plurality of holes for receiving liquid therethrough. The plurality of holes are configured as raised shields to block light and receive air, water, and nutrients. The container is configured with at least one center opening therethrough having an inner wall for receiving a plant. The center opening has at least one longitudinal opening extending therefrom to outer wall to allow placement of container on plant or to allow removal of container from plant. The container is configured with a plurality of stakes extending therefrom the base portion for providing stability for apparatus to be secured in plant growing medium.

### CROSS-REFERENCES TO RELATED APPLICATIONS

This application is a continuation-in-part patent application of U.S. application Ser. No. 17/096,669 filed on Nov. 12, 2020, the entire contents of which are hereby incorporated by reference.

### TECHNICAL FIELD

The present invention relates to the field of horticultural irrigation apparatus and watering systems, and more particularly, to an automated irrigation apparatus and system for feeding or watering plants and the like.

### BACKGROUND

Plants typically require feeding or watering or otherwise supplementing with liquid nutrition at least once weekly to survive. During occasions when an individual plans to be away from home for an extended period of time, the individual needs to make arrangements for the care of his or her plants. This involves the cost and inconvenience of hiring help to care for the plants and compromises the individual's privacy in the home or personal space.

Various self-watering plant watering or feeding apparatus and systems have been developed, but such apparatus and systems are not specifically designed for simple, convenient, and economical use due to their complex construction, and are not easily adaptable to an existing plant container or medium. It would thus be desirable to have an improved automated irrigation apparatus and system for feeding or watering plants and the like, which avoids the disadvantages of the known apparatus and systems.

### SUMMARY

In a first aspect, there is provided herein an irrigation apparatus for dispersing liquid through a plant growing medium. The apparatus includes a geometrically shaped container of variable size having an outer wall with an inner surface, an open top, and a base portion configured to cover the plant growing medium. The base portion is configured with a plurality of holes for receiving liquid therethrough. The container is configured with at least one center opening therethrough having an inner wall for receiving a plant. The at least one center opening has at least one longitudinal opening extending therefrom to the outer wall to allow placement of the container on the plant or to allow removal of the container from the plant. The container is configured with a plurality of geometrically shaped stakes of variable size extending therefrom the base portion for providing stability for the apparatus to be secured in the plant growing medium.

In certain embodiments, the plurality of holes are configured as raised shields or louvers to block light and receive air, water, and nutrients.

In certain embodiments, each corner of the base portion is configured with a hole to aid in the drainage of liquid from the container.

In certain embodiments, the container is configured with at least one hinge at a first end such that the container is opened and closed at a second end along with at least one of a clip or clamp via one male to one female ratio or other combinations of male to female ratios.

In certain embodiments, the outer wall of the container may be optionally configured with an adapter connectable to a variable size nozzle via a thread cap for use with a hose or pump system.

In certain embodiments, the container may be fabricated of a combination of translucent and opaque materials as separate parts or as an over mold that can be molded together such that the outer wall is translucent and the base portion is opaque for blocking light to the plant growing medium.

In certain embodiments, the at least one longitudinal opening is configured with an overhang lip portion at opposing sides for blocking light to the plant growing medium.

In a second aspect, there is provided herein an irrigation apparatus for dispersing liquid through a plant growing medium. The apparatus includes a geometrically shaped container of variable size having an outer wall with an inner surface, an open top, and a base portion configured to cover the plant growing medium. The base portion is configured with a plurality of holes for receiving liquid therethrough. The container is configured with at least one center opening therethrough having an inner wall for receiving a plant. The at least one center opening has at least one longitudinal opening extending therefrom to the outer wall to allow placement of the container on the plant or to allow removal of the container from the plant. The plurality of holes are configured with at least one dripper for receiving liquid extending therethrough the base portion such that the at least one dripper feeds the plant growing medium at variable flow rates and 25 intervals and provides stability for the apparatus to be secured in the plant growing medium. In certain embodiments, the container may be configured with an overhang lip portion formed around a top edge of the outer wall for blocking light to the plant growing medium.

In certain embodiments, the plurality of geometrically shaped louvers may be configured to receive at least one barbed louver insert for providing compatibility of the apparatus for use with an irrigation feeding system such that the barbed louver insert is configured to connect to a hose. In certain embodiments, the plurality of holes may be configured to receive at least one plug 5 having at least one hole for receiving liquid therethrough.

In a third aspect, there is provided herein an irrigation apparatus for dispersing liquid through a plant growing medium. The apparatus includes a geometrically shaped top of variable size configured with a plurality of holes for receiving liquid therethrough. The top is configured with at least one center opening therethrough having an inner wall for receiving a plant. The at least one center opening has at least one longitudinal opening extending therefrom to an outer wall to allow placement of the top on the plant or to allow removal of the top from the plant. The plurality of holes are configured with at least one dripper for receiving liquid extending therethrough the top such that the at least one dripper feeds the plant growing medium at variable flow rates and intervals and provides stability for the apparatus to be secured in the plant growing medium.

In certain embodiments, the plurality of holes are configured with an over mold ring disposed therearound for providing an improved seal and interchangeability of the at least one dripper into the top.

In certain embodiments, the over mold ring is fabricated from a rubber material or any suitable 20 elastic polymeric material.

In a fourth aspect, there is provided herein a dripper for use with an irrigation feeding system for dispersing liquid through a plant growing medium. The dripper includes an emitter top plug having a top surface and a bottom surface and a nozzle having a first end and a second end. The first end is configured to be affixed to the top surface of the emitter top plug. The dripper further includes a variable emitter path section having at least one torturous path to control liquid flow and an emitter bottom plug having at least one hole to discharge liquid therefrom. The emitter top plug and the emitter bottom plug are configured to encase the variable emitter path section. The dripper further includes a longitudinal exterior emitter plunger having an outer surface configured with a plurality of holes for dispersing liquid therethrough. The exterior emitter 30 plunger is configured to attach to the emitter bottom plug.

In certain embodiments, the longitudinal exterior emitter plunger may be configured with a break section for directing liquid to various points of a root zone within the plant growing medium.

In certain embodiments, the dripper further includes a longitudinal interior emitter plunger having a spiral wrapping affixed thereon such that the interior emitter plunger is configured to attach to the emitter bottom plug and be encased by the exterior emitter plunger.

In certain embodiments, the spiral wrapping is configured as a liquid path in which during 5 operation liquid flows down the spiral wrapping and dispenses from the exterior emitter plunger along various points of a root zone within the plant growing medium.

In certain embodiments, the nozzle is configured to be barbed.

In certain embodiments, the nozzle is affixed to the top surface of the emitter top plug by ultrasonic welding.

In certain embodiments, the nozzle is interchangeable and is affixed to the top surface of the emitter top plug by snapping in the top surface.

In certain embodiments, the nozzle is cylindrically shaped and is configured with a conical shaped interior section for receiving a hose.

In certain embodiments, the nozzle is configured to be pierced.

In certain embodiments, the nozzle is configured to be T-shaped having a first side and a second side such that each side is barbed for receiving a hose.

In certain embodiments, the dripper is configured for use with a pressured fogger or humidifier of an irrigation feeding system.

Various advantages of this disclosure will become apparent to those skilled in the art from the following detailed description, when read in light of the accompanying drawings.

### BRIEF DESCRIPTION OF THE DRAWINGS

FIG. 1 is a perspective view of an exemplary embodiment of the irrigation apparatus setting on top of a plant growing medium, according to the present disclosure.

FIGS. 2A-F are up close views of various geometric shapes of the irrigation apparatus of FIG. 1, according to the present disclosure.

FIG. 2G is an exemplary embodiment of the irrigation apparatus of FIG. 1, according to the present disclosure.

FIGS. 3A-B are side elevational views of the irrigation apparatus of FIG. 1 shown detached and having various male to female ratio configurations for the adjoining of first and second sides of the container, according to the present disclosure.

FIG. 4 is a side cross-sectional view of the base portion of the irrigation apparatus of FIG. 1 shown with a sloped or curved bottom.

FIG. 5 cross-sectional view of the irrigation apparatus of FIG. 1, according to the present disclosure.

FIG. 6 is a side cross-sectional view of another exemplary embodiment of the irrigation apparatus of FIG. 1, according to the present disclosure.

FIG. 7 is a side cross-sectional view of another exemplary embodiment of the irrigation apparatus of FIG. 1, according to the present disclosure.

FIG. 8 is a side elevational view of an exemplary embodiment of an irrigation feeding system using the irrigation apparatus of FIG. 1, according to the present disclosure.

FIG. 9A is a front elevational view of a digital moisture meter used in accordance with the irrigation apparatus and irrigation feeding system of the present disclosure.

FIG. 9B is a side elevational view of the digital moisture meter of FIG. 9A connected to the outer wall of the container, according to the present disclosure.

FIG. 10 is a perspective view of an exemplary embodiment of the irrigation apparatus setting on top of a plant growing medium, according to the present disclosure.

FIG. 11 is an exploded perspective view of an exemplary embodiment of the irrigation apparatus and plant growing medium, according to the present disclosure.

FIG. 12 is an enlarged top view of another exemplary embodiment of the irrigation apparatus, according to the present disclosure.

FIG. 13 is side cross-sectional view of an exemplary embodiment of the irrigation apparatus of FIG. 10, according to the present disclosure.

FIG. 14 is a bottom perspective view of the irrigation apparatus of FIG. 10, according to the present disclosure.

FIG. 15 is a top perspective view of another exemplary embodiment of the irrigation apparatus of FIG. 10, according to the present disclosure.

FIG. 16 is an exploded top perspective view of an exemplary embodiment of the irrigation apparatus, according to the present disclosure.

FIG. 17 is a top perspective view of an exemplary embodiment of the irrigation apparatus as a circle, according to the present disclosure.

FIG. 18 is a bottom perspective view of the irrigation apparatus of FIG. 17, according to the present disclosure.

FIG. 19 is a side elevational view of an exemplary embodiment of an irrigation feeding system using the irrigation apparatus of FIG. 13, according to the present disclosure.

FIG. 20A is a top view of an exemplary embodiment of an irrigation apparatus, according to the present disclosure.

FIG. 20B is a cross-sectional view of the irrigation apparatus of FIG. 20A, according to the present disclosure.

FIG. 20C is a cross-sectional view of another embodiment of the irrigation apparatus of FIG. 20A, according to the present disclosure.

FIG. 21 is a perspective view showing a dripper pop out the covering structure and pass through the reserved hole.

FIG. 22 is a top view of another embodiment of an irrigation apparatus, according to the present disclosure.

FIG. 23 is an enlarged top view of another exemplary embodiment of the irrigation apparatus, according to the present disclosure.

FIG. 24A is a top perspective view of an exemplary embodiment of an irrigation apparatus, according to the present disclosure.

FIG. 24B is a partial bottom perspective view of the irrigation apparatus of FIG. 24A, according to the present disclosure.

FIG. 25 is a top perspective view of an exemplary embodiment of a holed dripper cap, according to the present disclosure.

FIG. 26 is an elevational side view of a barbed louver insert for use with the irrigation apparatus of FIG. 24A, according to the present disclosure.

FIG. 27 is a side elevational view of an exemplary embodiment of the irrigation feeding system of FIG. 19 with a pressured fogger, according to the present disclosure.

### DETAILED DESCRIPTION

This disclosure is not limited to the particular systems, methodologies or protocols described, as these may vary. The terminology used in this description is for the purpose of describing the particular versions or embodiments only, and is not intended to limit the scope.

As used in this document, the singular forms “a,’ an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

In consideration of the figures, it is to be understood for purposes of clarity certain details of 25 construction and/or operation are not provided in view of such details being conventional and well within the skill of the art upon disclosure of the document described herein.

The following terms and phrases shall have, for purposes of this application, the respective meanings set forth below:

The terms “feeding” and “watering” are used interchangeably herein and are intended to have the 30 same meaning with respect to the treating of a plant with liquid nutrition so that the plant may grow and flourish.

The terms “dripper” and “emitter” are used interchangeably herein and are intended to have the same meaning with respect to drip irrigation in assuring that a uniform rate of flow of liquid is achieved.

The term “irrigation” refers to the application of water to soil or another medium by artificial means to foster plant growth.

The terms “growing medium,’ ‘medium,” or “media” refer to a liquid or solid in which organic structures such as plants are placed to grow.

The term “liquid” refers to any form of liquid nutrition for a plant, including water and the like.

The phrases “pressure compensating subsurface dripper or emitter” and “subsurface pressure compensating dripper or emitter” are used interchangeably herein and refer to a dripper or emitter that is forced into the growing medium while not compromising the flow of the drip by encasing the drip and not allowing anything to interfere with the dripper or emitter's set course. The term “Rockwool” refers to the inorganic mineral based horticultural grade Rockwool primarily sold as a hydroponic substrate in the horticultural industry.

The phrase “substrate growing system” is a hydroponic system in which the root zone is physically supported by media and the plants are fed by applying nutrient solution to the media. The irrigation apparatus and irrigation feeding system of the present disclosure pertains to a self-watering irrigation apparatus and feeding system that allows a user to measure the amount of water as it is distributed onto a plant instead of pre-measuring or doing a count; provides for a slow thorough and even distribution of water or other liquid nutrition; prevents algae, mold, and weeds from growing in the plant growing medium by covering the medium in its entirety; low cost to manufacture; fabricated from inexpensive materials; durable; and easy to assemble and disassemble, among other desirable features as described herein.

It is contemplated by the present disclosure that the irrigation apparatus and irrigation feeding 25 system may be used with any suitable plant growing medium (e.g., Rockwool, soil, and the like) in a substrate growing system.

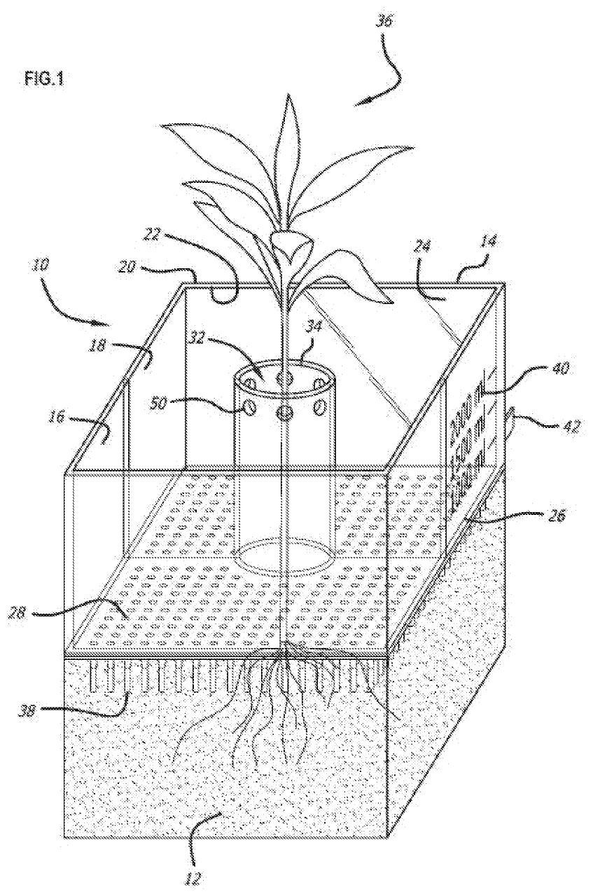

Referring now to FIG. 1 is a perspective view of an exemplary embodiment of the irrigation apparatus 10 setting on top of a plant growing medium 12 (e.g., Rockwool) according to the present disclosure. The irrigation apparatus 10 includes a geometrically shaped container 14 of variable size configured to be detachable in at least two pieces at a first side 16 and a second side 18. The container 14 has an outer wall 20 with an inner surface 22, an open top 24, and a base portion 26 configured to cover the plant growing medium 12. The base portion 26 is configured with a plurality of holes 28 for receiving liquid 30 therethrough.

As illustrated in FIG. 1, the container 14 is configured with at least one center opening 32 therethrough and includes an inner wall 34 for receiving a plant 36 when the first side 16 and the second side 18 of the container are adjoined together as a single container. The plurality of holes 28 are each configured with a dripper 38 for receiving liquid 30 extending therethrough the base portion 26 such that the dripper feeds the plant growing medium 12 at variable flow rates and intervals and provides stability for the apparatus 10 to be secured in the plant growing medium. It should be understood that the dripper may be configured to feed the plant growing medium at 10 any suitable flow rate and interval in accordance with the present disclosure.

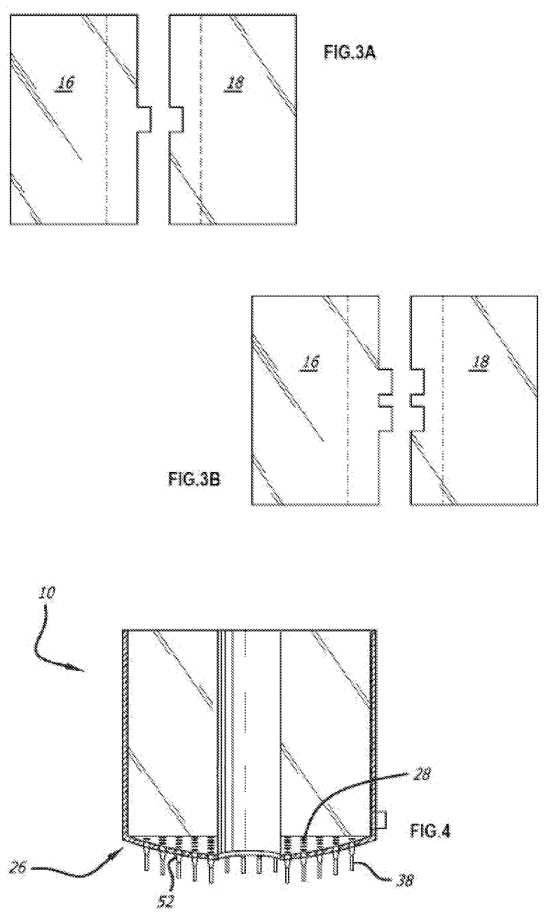

In accordance with the present disclosure, the geometrically shaped container 14 can be fabricated either as a single piece or as at least two separate pieces that are configured to be adjoined together at the first side 16 and the second side 18. The at least two piece configuration allows for easy installation or tear down of the container 14 by the user. In some embodiments, the first side 16 and the second side 18 are configured to be adjoined or secured together via at least a one male to one female ratio (FIG. 3 A) or other suitable combinations of male to female ratios, including, but not limited to, male to two female, two male to three female, or two male to two female (FIG. 3B), and the like. It should be understood that the first side 16 and the second side 18 may be adjoined or secured together via any suitable notch configured within the female and end of the male.

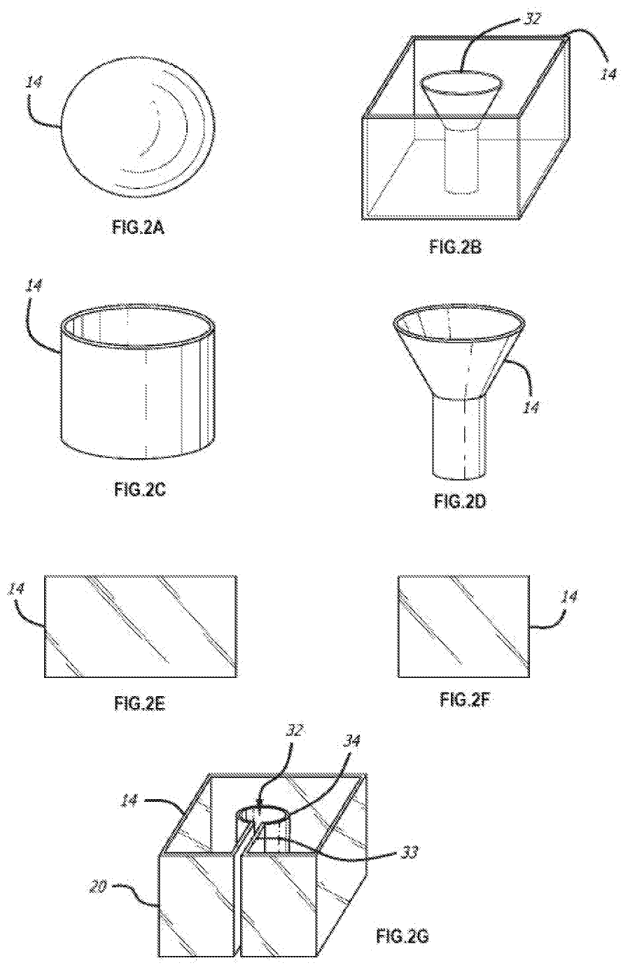

In one embodiment, the geometrically shaped container 14 can be a circle (FIG. 2A), cube (FIG. 2B), cylinder (FIG. 2C), conical (FIG. 2D), rectangle (FIG. 2E), square (FIG. 2F), or any other suitable geometrical shape. It should be understood that the container can be manufactured to suit any plant size growing medium and is sized to scale. For example, the container may be a cube with dimensions of 8 inches (height)×8 inches (width)×8 inches (length) and outer walls of 3/16 of an inch thick such that the container fits a Rockwool cube of same approximate dimensions.

The container may be fabricated of any sturdy material capable of retaining liquids or fluids (e.g., water), including metal, plastic, and the like.

In one embodiment, the geometrically shaped container 14 is transparent or clear having a measuring table 40 disposed thereon the inner surface 22, as illustrated in FIG. 1. It should be understood that the amount of volume each unit or container 14 can hold will be according to scale such that a plant growing in a 4 inches×4 inches×4 inches Rockwool cube does not require the same amount of liquid nutrition as a plant in a five gallon pot. For example, the measuring table 40 for a plant growing in an 8 inches×8 inches×8 inches Rockwool cube will allow up to approximately 2000 ml of liquid nutrition. Alternatively, the measuring table 40 for a plant growing in a 6 inches×6 inches×6 inches Rockwool cube will allow up to approximately 1200 ml of liquid nutrition.

In accordance with the present disclosure, the outer wall 20 of the container 14 may be configured with an adapter 42 for use with a hose 44 or pump 46 system, such that the irrigation apparatus 10 may be used in conjunction with the irrigation feeding system 48 disclosed herein. In some embodiments, the adapter 42 may be 0.5 inches in size with a cap for use with or without the irrigation feeding system or a hose or pump system that the user may wish to apply. It should be understood that the adapter can be of any type and size suitable for connecting the hose to the container.

In some embodiments, the container 14 is configured to include a plurality of variable size openings 50 disposed on the inner wall 34 for use as a flood drain for excess liquid retained in the container during feeding of the plant 36 to be directed to the center of the plant growing medium 12. It should be understood that the openings 50 disposed on the outer wall can be of any suitable size or dimension, preferably within the range of from about ⅛ of an inch to about one inch. In one embodiment, the openings are configured to be about ⅛ of an inch, such that 20 excess liquid can flow therethrough and be directed to the areas where the plant requires additional moisture.

The at least one center opening 32 of the inner wall 34 for receiving the plant 36 may be circular (FIG. 1), conical (FIG. 2B), or cylindrical (FIG. 2C) to accommodate various sizes of plants. It should be understood that the container 14 may be configured with multiple center openings to allow multiple plants to be received. In one embodiment, the at least one center opening 32 is fabricated to have about a two inch diameter, which enables the base of the plant 36 space to grow in the plant growing medium 12. It should be understood that the at least one center opening can be configured of any suitable size and is sized to scale relative to the size of the container.

Referring to FIG. 2G is a side cross-sectional view of an exemplary embodiment of the irrigation apparatus of FIG. 1 according to the present disclosure. Specifically, the at least one center opening 32 can be configured to have at least one longitudinal opening 33 extending therefrom to the outer wall 20 to allow placement of the container 14 on or removal of the container from the plant 36. In this embodiment, the container is configured to bend to fit around the base of variable size plants. The at least one longitudinal opening 33 is configured to have the same height wall as the outer wall 20 of the container 14 while receding to a variable degree to the inner wall 34 of the at least one center opening 32.

FIG. 4 is a side cross-sectional view of the base portion 26 of the irrigation apparatus 10 of FIG. 1 shown with a sloped or curved bottom. In some embodiments, the base portion 26 may be flat (FIG. 1) or curved (FIG. 4). The base portion 26 may be configured to decline outward to inward from about ⅜ of an inch to about 3/16 of an inch in the curved embodiment such that the liquid 30 flows downward through the plurality of holes 28 into the dripper 38 for feeding the plant growing medium 12. The plurality of holes 28 of the base portion 26 may be configured to be about ¼ of an inch and gradually recede to about a 1/16 of an inch to about 1/64 of an inch chamber 52 of the dripper 38. It should be understood that the plurality of holes and the dripper can be sized to scale as appropriate. The number of drippers 38 used in conjunction with the irrigation apparatus 10 can range from about one or greater, according to the present disclosure.

FIG. 5 is a top cross-sectional view of the irrigation apparatus 10 of FIG. 1 according to the present disclosure. In some embodiments, the plurality of holes 28 of the base portion 26 are variably sized such that the holes retain the liquid in the container 14 for about 10 to about 60 minutes during feeding of the plant 36. It should be understood that the plurality of holes of the base portion can be configured to retain the liquid in the container for other suitable time intervals or periods other than disclosed herein during feeding of the plant.

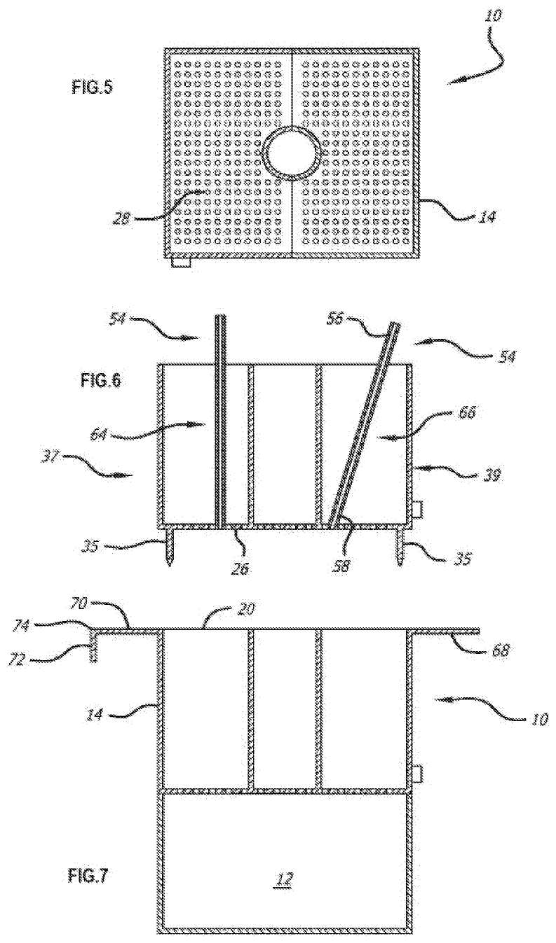

FIG. 6 is a side cross-sectional view of another exemplary embodiment of the irrigation apparatus according to the present disclosure. Specifically, the container 14 can be configured with at least two stakes 35 disposed at a first end 37 and a second end 39 of the container for securing the container in the plant growing medium 12. In accordance with the present disclosure, the at least two stakes 35 can be used when the dripper 38 is laser tubing.

Referring further to FIG. 6, the container 14 may include at least one longitudinal section 54 having a first end 56 and a second end 58 such that the second end is attached to the base portion 26. The longitudinal section 54 is configured with an opening 60 therethrough for receiving a support structure 62, such as a bamboo, wood, or plastic stick, from the first end 56 to the second end 58 such that at least a portion of the support structure is positioned in the plant growing medium 12 for providing additional support to the plant and plant growing medium 12. In one embodiment, the at least one longitudinal section 54 is about ¼ inch thick and the opening 60 is about ¼ inch to about ½ inch wide according to scale. The at least one longitudinal section 54 may be configured to be positioned perpendicular 64 or angled 66 in relation to the base portion 26. It should be understood that the at least one longitudinal section can be configured of any suitable size and is sized to scale. FIG. 7 is a side cross-sectional view of another exemplary embodiment of the irrigation apparatus 10 according to the present disclosure. In particular, the container 14 includes an overhang lip portion 68 formed on a top edge 70 of the outer wall 20 for blocking light to the plant growing medium 12. By covering the plant growing medium 12 from light, the irrigation apparatus 10 prevents algae, mold, and weeds from growing in the plant growing medium. In another embodiment, the overhang lip portion 68 includes a downward lip 72 extending therefrom a first end 74 of the overhang lip portion for blocking light to the plant growing medium 12. It should be understood that the overhang lip portion and downward lip can be of any suitable size such that light is blocked to the plant growing medium and is sized to scale.

The overhang lip portion 68 and downward lip 72 may be fabricated of any opaque material suitable for blocking light, including metal, plastic, stone, wood, and the like.

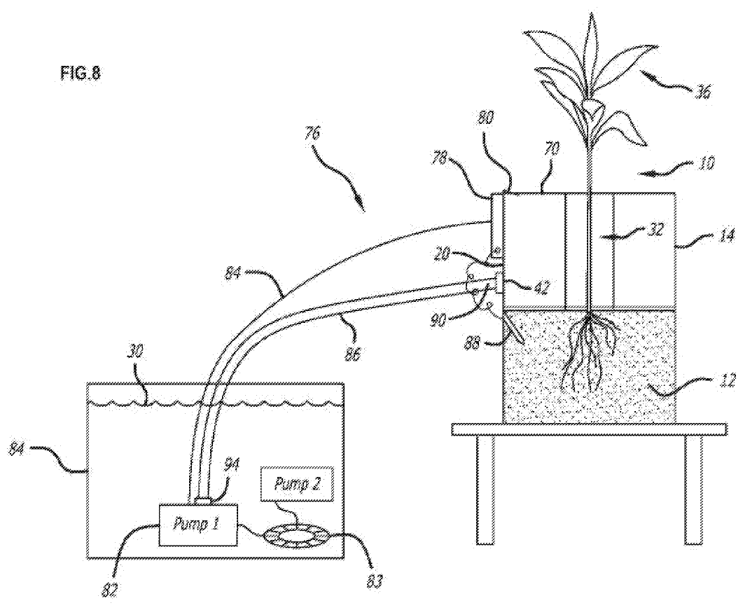

FIG. 8 is a side elevational view of an exemplary embodiment of the irrigation feeding system using the irrigation apparatus of FIG. 1 according to the present disclosure. The irrigation feeding system 76 for dispersing liquid 30 through a plant growing medium 12 includes the irrigation apparatus 10 as previously disclosed above. In some embodiments, the container 14 is configured to be detachable in at least two pieces at first side 16 and second side 18. The first side 16 and second side 18 are configured to be adjoined or secured together via at least one male to one female ratio or other combinations of male to female ratios as previously disclosed above.

The irrigation feeding system 76 further includes a digital moisture meter 78 removably connected to the outer wall 20 for monitoring moisture levels of the plant growing medium 12. The digital moisture meter 78 can be connected to the outer wall 20 of the container 14 via a hinged clip or clamp 80 integral to the digital moisture meter or separate therefrom or via a material that slides on to the top edge 70 of the outer wall 20.

At least one moisture sensor 88 for monitoring moisture levels of the plant growing medium 12 may be optionally used in combination with the digital moisture meter 78 such that the at least one moisture sensor is optimally positioned at a variable angle in the plant growing medium proximate to the digital moisture meter as shown in FIG. 8. In some embodiments, the at least one moisture sensor 88 may be positioned at about a 45 degree angle from the digital moisture meter 78 such that the sensor penetrates to the approximate center of the plant growing medium 12 for an accurate reading.

A submersible pump 82 positioned inside a liquid holding reservoir 84 pumps liquid to the irrigation apparatus 10. The submersible pump can be any suitable aquarium pump as used in fish tank aquariums. The liquid holding reservoir may be fabricated of any sturdy material capable of retaining liquids or fluids (e.g., water), including metal, plastic, and the like. The submersible pump 82 is configured to be connected to the digital moisture meter 78 by at least one wire 84 for communication therewith the digital moisture meter. The wire can be connected from the pump to the digital moisture meter via a waterproof connection of the type manufactured by King Innovation (O'Fallon, Mo.) called DRYCONN®.

In some embodiments, the irrigation feeding system 76 may be used with a plurality of submersible pumps 82 on a submersible power strip 83 having a single power supply.

The irrigation feeding system 76 further includes a hose 86 having a first end 90 and a second end 92 such that the first end of the hose is configured to be connected to an adapter 94 disposed on the submersible pump 82 and the second end of the hose is configured to be connected to adapter 42 disposed on the outer wall 20 of the container 14. Liquid 30 is pumped from the liquid holding reservoir 84 through the hose 86 to the container 14 such that liquid is dispersed through the plant growing medium 12 at appropriate flow rates and intervals when the plant 36 reaches a predetermined moisture and humidity level. It should be understood that the irrigation feeding system disperses liquid into the plant growing medium at any appropriate flow rate and interval when a predetermined moisture and humidity level is reached by the plant. For example, a volume of 2000 ml of liquid is dispersed into the plant growing medium within a period of about 10 minutes.

The irrigation apparatus and irrigation feeding system of the present disclosure can be used with any suitable drippers or emitters, such as those with an extremely small hole in the tube (e.g., soaker hose, porous pipe, drip tape, laser tubing), those that work well on very low-pressure systems (e.g., short-path emitters), and those that are less likely to clog up (e.g., tortuous-path or turbulent-flow emitters). Drippers or emitters are manufactured in a variety of different flow rates. The most common flow rates, suitable for use with the irrigation apparatus and irrigation feeding system of the present disclosure, include as follows:

2.0 liters/hour—½ gallon/hour

4.0 liters/hour—1 gallon/hour

8.0 liters/hour—2 gallons/hour

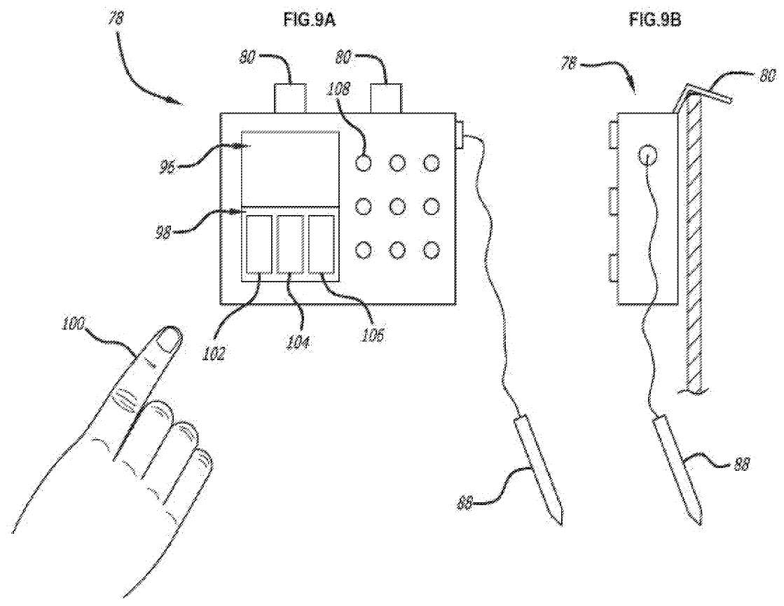

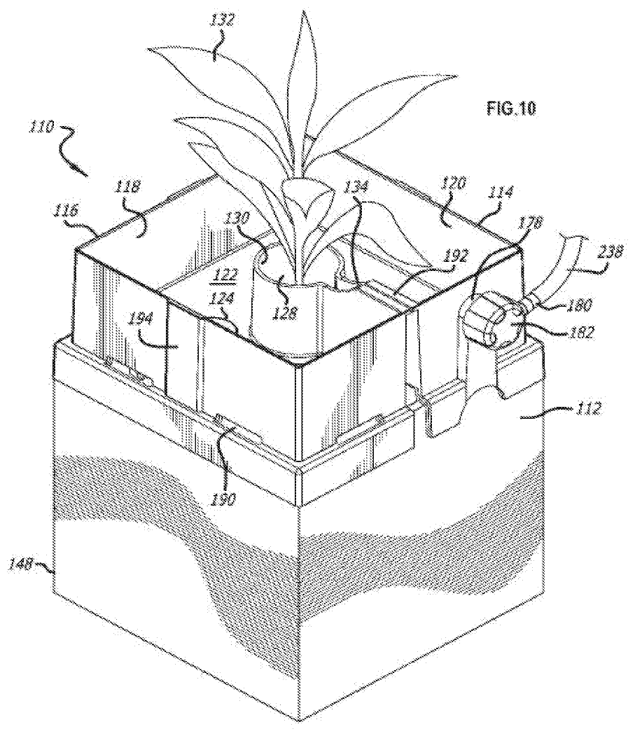

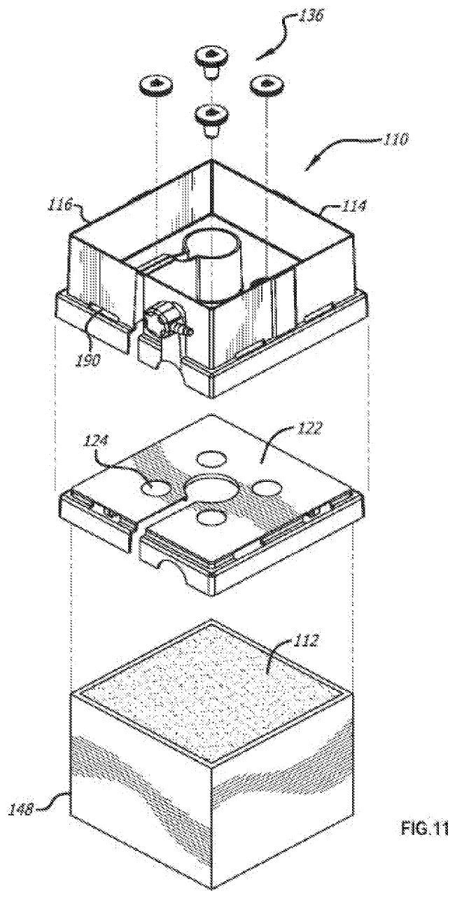

FIG. 9A is a front elevational view of a digital moisture meter 78 used in accordance with the irrigation apparatus 10 and irrigation feeding system 76 of the present disclosure. The digital moisture meter 78 includes a digital moisture display 96 such that when used with a plurality of manual functions, the display provides variable settings 98 for a specific moisture level at which a user 100 would like the irrigation feeding system to feed the plant growing medium. In some embodiments, the plurality of manual functions enable a user 100 to view feeding history 102, set times 104, feeding schedules 106, and manually operate the digital moisture meter via an on/off button or switch 108. Specifically, feeding history may include the number of times the plant has fed since the last time a user has checked as well as the dates and times the plant has fed. Setting times include use of a clock for setting how many seconds and/or minutes the user would like the pump to be on in filling up the irrigation apparatus. Feeding schedules include use of a calendar for adjusting the moisture level of the plant to be a certain level for specific days, weeks, or months. The manual on/off button or switch enables the user to calculate how many seconds or minutes it takes to fill up the irrigation apparatus.

FIG. 9B is a side elevational view of the digital moisture meter 78 connected to the outer wall 20 of the container 14 by hinged clip or clamp 80 according to the present disclosure.

Referring now to FIG. 10 is a perspective view of an exemplary embodiment of irrigation apparatus 110 setting on top of a plant growing medium 112 (e.g., Rockwool) according to the present disclosure. The irrigation apparatus 110 includes a geometrically shaped container 114 of variable size having an outer wall 116 with an inner surface 118, an open top 120, and a base portion 122 configured to cover the plant growing medium 112. The base portion 122 is configured with a plurality of holes 124 for receiving liquid 126 therethrough.

The container 114 is configured with at least one center opening 128 therethrough and includes an inner wall 130 for receiving a plant 132. The at least one center opening 128 has at least one longitudinal opening 134 extending therefrom to the outer wall 116 to allow placement of the container 114 on the plant 132 or to allow removal of the container from the plant. In this embodiment, the container is configured to bend to fit around the base of variable size plants. The at least one longitudinal opening 134 is configured to have the same height wall as the outer wall 116 of the container 114 while receding to a variable degree to the inner wall 130 of the at least one center opening 128. It should be understood that the at least one center opening can be configured of any suitable size and is sized relative to the size of the container.

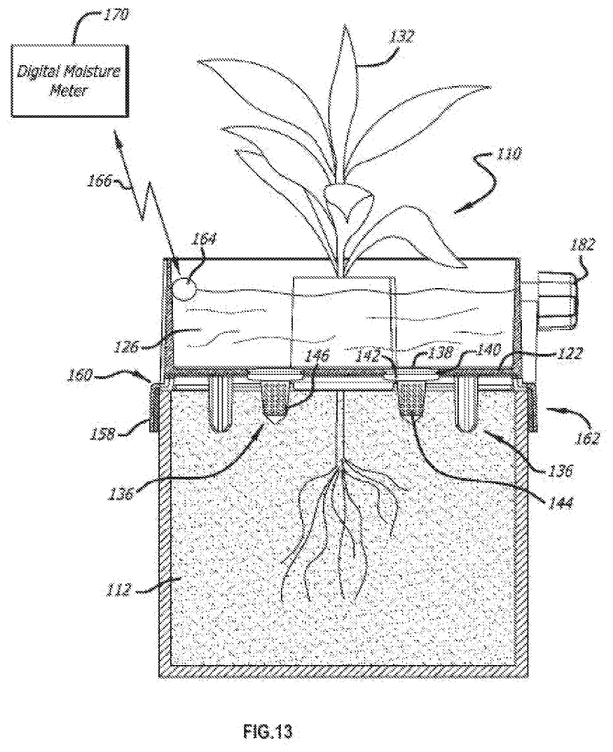

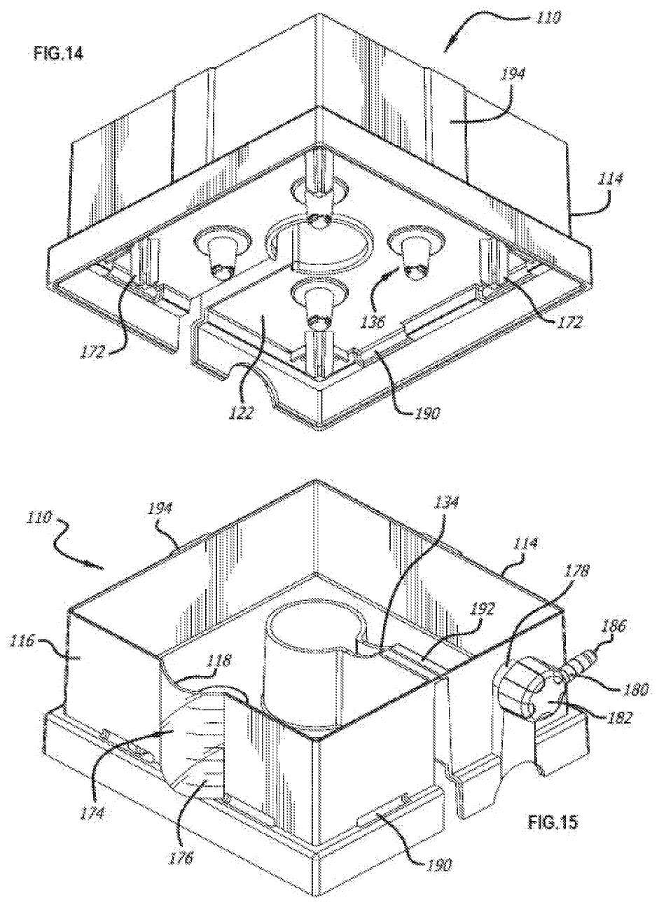

As illustrated in FIGS. 13 and 14, the plurality of holes 124 are configured with at least one dripper 136 for receiving liquid 126 extending therethrough the base portion 122 such that the at least one dripper feeds the plant growing medium 112 at variable flow rates and intervals and provides stability for the apparatus 110 to be secured in the plant growing medium. It should be understood that the dripper may be configured to feed the plant growing medium at any suitable flow rate and interval in accordance with the present disclosure.

In accordance with the present disclosure, the at least one dripper 136 is configured to be interchangeable and replaceable with same or different variable flow rate emitters such that the at least one dripper can snap in, fit flush, screw in, or be releasably secured from the base portion 122, as illustrated in FIGS. 11-14 and 17-21. The at least one dripper 136 includes an emitter top plug 138, a variable emitter path section 140 to control liquid flow, an emitter bottom plug 142, and an emitter plunger 144, which encases the drip and is secured in the plant growing medium 112. The at least one dripper 136 may be configured with a plurality of holes 146 therethrough such that multiple drips originate from the at least one dripper. It should be understood that the drippers can come in different sizes (i.e., longer stakes or paths from the initial drip to the chosen depth of the media, large hole sizes in the tortuous path, different or alternative tortuous paths, etc.) such that they may be used as self-standing units for and/or along with other irrigation techniques (i.e., subsurface pressure compensating drippers or emitters built into a garden hose and/or in conjunction therewith).

The drippers or emitters disclosed herein can be fabricated of any suitable material, such as plastic (e.g., acrylonitrile butadiene styrene (ABS)), synthetic polymers (e.g., nylon), and the like.

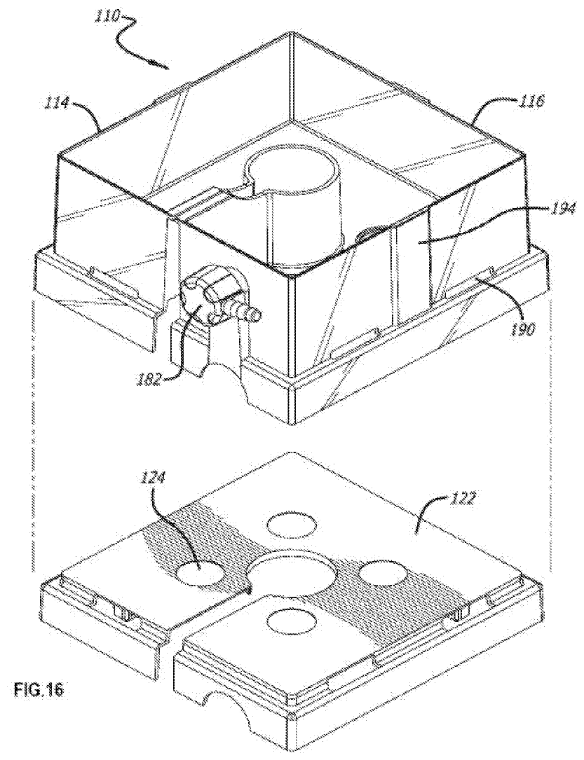

FIGS. 11 and 16 are exploded perspective views of an exemplary embodiment of the irrigation apparatus 110 according to the present disclosure. In accordance with the present disclosure, the container 114 may be fabricated of a combination of translucent and opaque materials as two separate parts or as an over mold that can be molded together such that the outer wall 116 of the container 114 is translucent and the base portion 122 is opaque for blocking light to the plant growing medium 112.

As with the earlier embodiments described herein, it should be understood that the container 114 may be fabricated of any sturdy material capable of retaining liquids or fluids (e.g., water), including metal, plastic, and the like. It should be further understood that the container 114 can be manufactured to suit any plant size growing medium and is sized to scale.

In one embodiment, the container 114 is configured to be secured flush with a plant container or pot 148 (FIG. 10) such that the container is disposed inside of the plant container or pot by at least one of screwing, clamping, and clipping.

In a further embodiment, the container 114 is configured to be used with structurally supported or adhered finishes of the plant container or pot 15 (FIGS. 10-11) such that a finished appearance of the container and plant container or pot may be achieved.

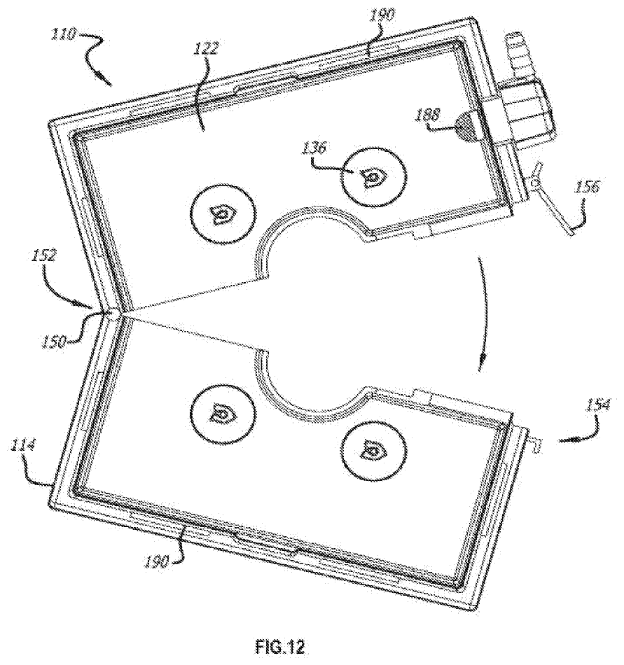

FIG. 12 is an enlarged top view of another exemplary embodiment of the irrigation apparatus 110 according to the present disclosure. The container 114 is configured with at least one hinge 150 or other suitable movable mechanism at a first end 152 such that the container is opened and closed at a second end 154 along with at least one of a clip or clamp 156 or via one male to one female ratio or other combinations of male to female ratios.

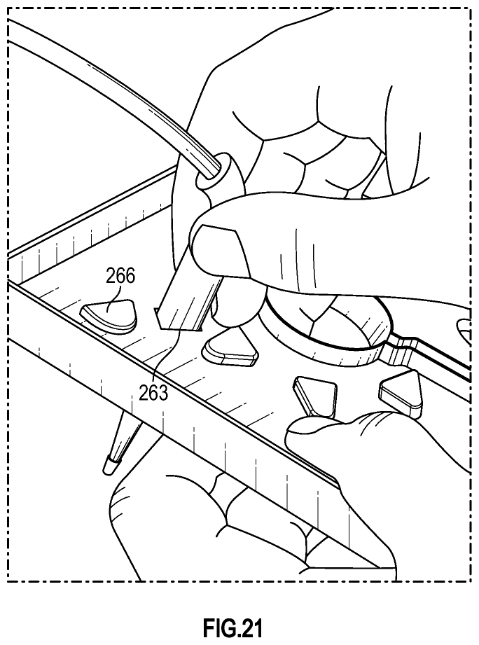

In some embodiments, a floating bobber 164 is triggered upon the liquid 126 reaching a predetermined volume in the container 114. The floating bobber 164 is configured to be wired or wireless such that a signal 166 can be transmitted to a submersible pump 168 (FIG. 21) or an intercepting device 170 (e.g., digital moisture meter) used in combination with the container 114 when the liquid 126 has reached a predetermined volume in the container.

FIG. 14 is a bottom perspective view of the irrigation apparatus 110 of FIG. 10 according to the present disclosure. In one embodiment, the container 114 is configured with a plurality of geometrically shaped stakes 172 of variable size extending therefrom the base portion 122 for providing stability of the container to the plant growing medium 112. It should be understood that the geometrically shaped stakes can be fabricated of any suitable material and size for providing stability of the container in the plant growing medium.

FIG. 15 is a top perspective view of another exemplary embodiment of the irrigation apparatus of FIG. 10 according to the present disclosure. In one embodiment, at least one side of the outer wall 116 is configured with a transparent insert 174 having a measuring table 176 disposed thereon the inner surface 118 for assisting the user with measuring while filling the container 114 with liquid.

In accordance with the present disclosure, the outer wall 116 of the container 114 may be configured with an adapter 178 connectable to a variable size nozzle 180 via a thread cap 182 for use with a hose or pump system (FIG. 21). In some embodiments, the variable size nozzle 180 is barbed and is closeable at one end 184 via a plug 186, as illustrated in FIG. 15. The thread cap 182 is configured to have a portable or built in filter 188 (FIG. 12) disposed therein.

In some embodiments, each side of the outer wall 116 is configured with at least one slot 190 for aeration, as illustrated in FIGS. 10-12 and 14-16. It should be understood that the at least one slot may be configured of any suitable size and shape for aeration.

In some embodiments, the at least one longitudinal opening 134 is configured with an overhang lip portion 192 at opposing sides for blocking light to the plant growing medium 112. It should be understood that the overhang lip portion can be configured of any suitable material, shape, and size for blocking light to the plant growing medium.

In further embodiments, the outer wall 116 is configured with a plurality of longitudinal braces 194 for supporting the container 114 in the plant growing medium 112 when the container is geometrically shaped as a cube, rectangle, or square. The longitudinal braces may be fabricated of any suitable material, such as plastic, rubber, and the like.

FIG. 17 is a top perspective view of an exemplary embodiment of the irrigation apparatus 110 geometrically shaped as a circle according to the present disclosure. In some embodiments, the base portion 122 is configured with a plurality of ribbed braces 196 for supporting the container 114 in the plant growing medium 112 when the container is geometrically shaped as a circle, cylinder, or cone.

As with previous embodiments (FIG. 6) of irrigation apparatus 10, the irrigation apparatus 110 geometrically shaped as a circle may include a plurality of longitudinal sections 198 having a first end 200 and a second end 202 such that the second end is attached to the base portion 122. The plurality of longitudinal sections 198 are configured with an opening 204 therethrough for receiving a support structure (FIG. 6), such as bamboo, wood, or plastic stick, from the first end 200 to the second end 202 such that at least a portion of the support structure is positioned in the plant growing medium for providing additional support to the plant and plant growing medium.

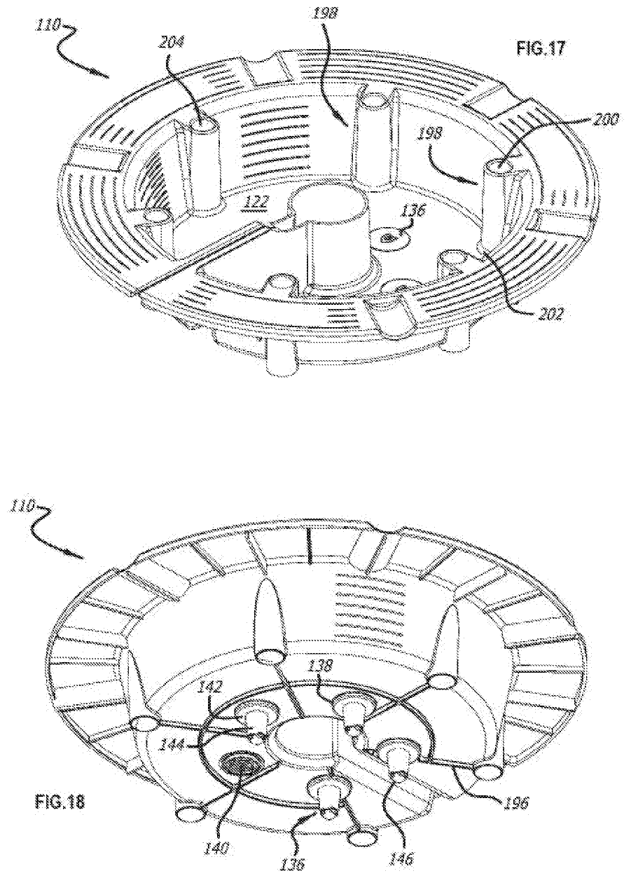

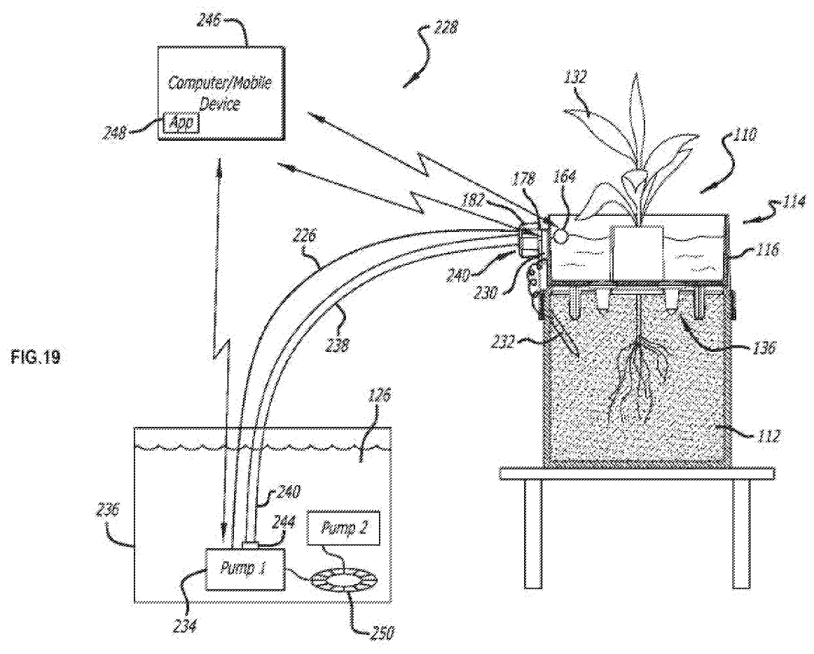

FIG. 18 is a bottom perspective view of the irrigation apparatus 110 of FIG. 17 according to the present disclosure.

FIG. 19 is a side elevational view of an exemplary embodiment of an irrigation feeding system 228 using the irrigation apparatus of FIG. 13 according to the present disclosure. The irrigation feeding system 228 for dispersing liquid 126 through a plant growing medium 112 includes the irrigation apparatus 110 as previously disclosed above.

The irrigation feeding system 228 further includes a digital moisture meter 230 removably connected to the outer wall 116 for monitoring moisture levels of the plant growing medium, at least one moisture sensor 232 for monitoring moisture levels of the plant growing medium 112 optionally used in combination with the digital moisture meter 230, a submersible pump 234 positioned inside a liquid holding reservoir 236 for pumping liquid to the apparatus 110, and a hose 238, as previously disclosed above in connection with the irrigation feeding system 48 of FIGS. 8 and 9A-9B. The submersible pump 234 is configured to be connected to the digital moisture meter 230 by at least one wire 226 for communication therewith. The hose 238 includes a first end 240 and a second end 242 such that the first end of the hose is configured to be connected to an adapter 244 disposed on the submersible pump 234 and the second end of the hose is configured to be connected to a nozzle 180 via a thread cap 182 and an adapter 178 disposed on the outer wall 116 of the container 114. Liquid 126 is pumped from the liquid holding reservoir 236 through the hose 238 to the container 114 such that liquid is dispersed through the plant growing medium 112 at appropriate flow rates and intervals when the plant reaches a predetermined moisture and humidity level. As with the prior embodiments of the irrigation feeding system 48, it should be understood that the irrigation feeding system 228 disperses liquid into the plant growing medium at any appropriate flow rate and interval when a predetermined moisture and humidity level is reached by the plant.

It should be understood that the irrigation feeding system 228 may be used with a plurality of submersible pumps 234 on a submersible power strip 250 having a single power supply.

In some embodiments, wireless features may be enabled to interact with a computer or mobile device 246 such that an App 248 can program or monitor the irrigation feeding system 228 to view feeding history, set times, feeding schedules, and operate the digital moisture meter 230.

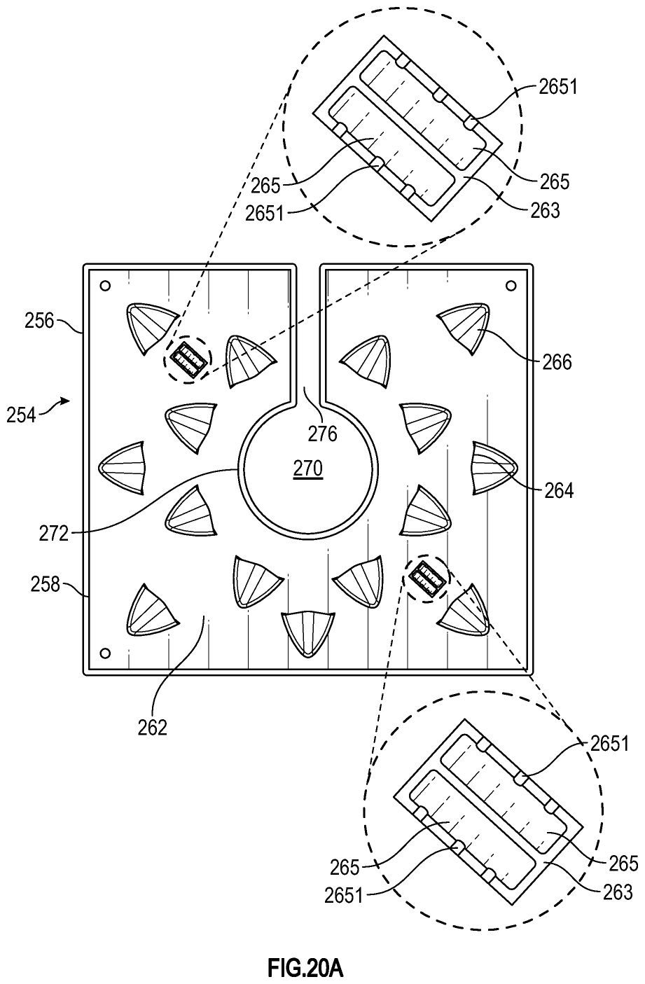

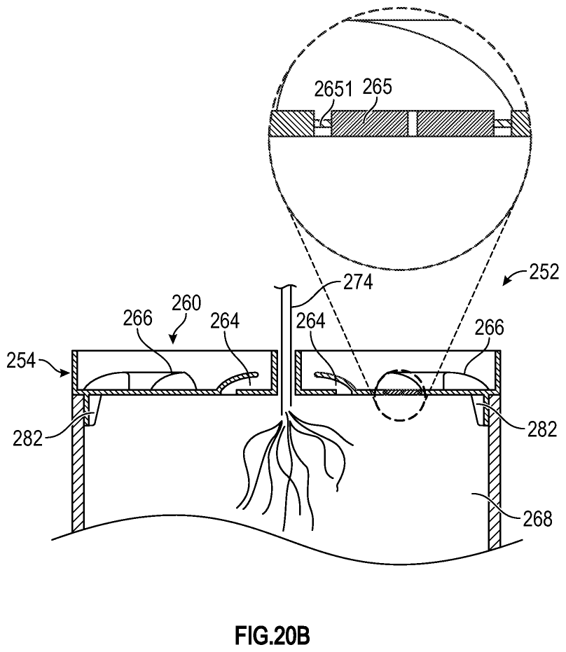

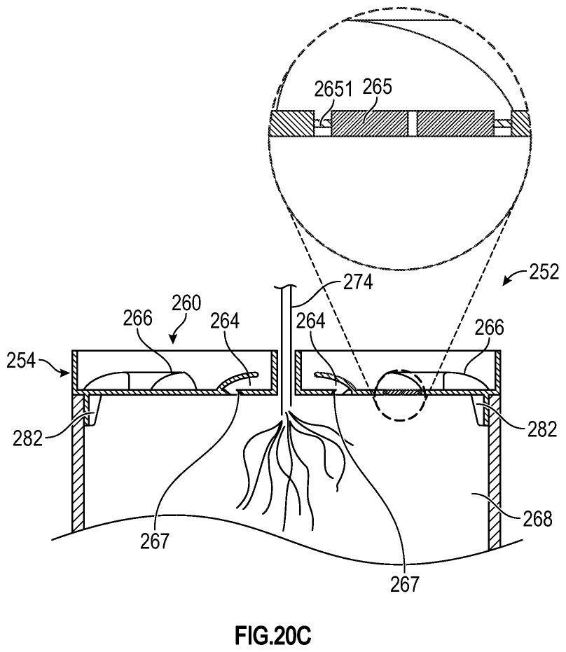

Referring now to FIG. 20A is a top view of an exemplary embodiment of an irrigation apparatus 252 according to the present disclosure. The irrigation apparatus includes a geometrically shaped container 254 of variable size having an outer wall 256 with an inner surface 258, an open top 260, and a base portion 262 configured with a plurality of holes 264 for receiving liquid therethrough. The plurality of holes 264 are configured as raised shields or louvers 266 to block light and receive air, water, and nutrients, for the plant growing medium 268. It should be understood that the raised shields or louvers can be configured of any suitable size and are sized relative to the size of the container.

The container 254 is configured with at least one center opening 270 therethrough having an inner wall 272 for receiving a plant 274. The at least one center opening 270 has at least one longitudinal opening 276 extending therefrom to the outer wall 256 to allow placement of the container 254 on the plant 274 or to allow removal of the container from the plant. In this embodiment, the container is configured to bend to fit around the base of variable size plants. The at least one longitudinal opening 276 is configured to have the same height wall as the outer wall 256 of the container 254 while receding to a variable degree to the inner wall 272 of the at least one center opening 270. It should be understood that the at least one center opening can be configured of any suitable size and is sized relative to the size of the container.

Furthermore, the container 254 is configured with a plurality of reserved holes 263, and there is a covering structure 265 connected to each of the reserved holes 263, and the covering structures 265 can be removed from the reserved holes 263 to insert additional drippers or additional stakes through the reserved holes 263 while needed. In addition, the covering structure 265 is connected to each of the reserved holes 263 through a plurality of gates 2651, and while removing the covering structures 265, external force will be applied to the covering structures 265, then the gates 2651 will be broken, causing the covering structures 265 to pop out from the reserved holes 263.

In some embodiments, the at least one longitudinal opening 276 is configured with an overhang lip portion at opposing sides for blocking light to the plant growing medium 268. It should be understood that the overhang lip portion can be configured of any suitable material, shape, and size for blocking light to the plant growing medium.

In some embodiments, each corner of the base portion 262 is configured with a hole 280 to aid in the drainage of liquid from the container 254. It should be understood that the hole can be configured of any suitable size for drainage purposes.

FIG. 20B is a cross-sectional view of the irrigation apparatus 252 of FIG. 20A. As illustrated in FIG. 20B, the container is further configured with a plurality of geometrically shaped stakes 282 of variable size extending therefrom the base portion 262 for providing stability for the apparatus 252 to be secured in the plant growing medium 268.

In accordance with the present disclosure, the container 254 may be fabricated of a combination of translucent and opaque materials as two separate parts or as an over mold that can be molded together such that the outer wall 256 of the container 254 is translucent and the base portion 262 is opaque for blocking light to the plant growing medium 268.

As with the earlier embodiments described herein, it should be understood that the container 254 may be fabricated of any sturdy material capable of retaining liquids or fluids (e.g., water), including metal, plastic, and the like. It should be further understood that the container 254 can be manufactured to suit any plant size growing medium and is sized to scale.

FIG. 20C is a cross-sectional view of another embodiment of the irrigation apparatus of FIG. 20A, according to the present disclosure. As illustrated in FIG. 20C, the raised shields 266 are formed and extended upward from the edge of the plurality of holes 264, and the plurality of holes 264 is configured as louver structures 267, so that the raised shields 266 and the louver structures 267 will work together to block light and receive air, water, and nutrients, for the plant growing medium 268. It should be understood that the raised shields 266 and louvers structures 267 can be configured of any suitable size and are sized relative to the size of the container 254.

In addition, there is an angle between a first direction of an opening of the raised shields 266 which faces outward and a second direction of each channel of the louver structures 267 which faces the plant growing medium 268. And, the range of the angle is around 30 degrees to 60 degrees, in this way, sun light won't able to directly irradiate to the plant growing medium 268 in any direction since the angle is not around 170 to 180 degrees. Furthermore, the inner surface of the raised shields 266 and/or the surface of the louver structures 267 can be coated with a light-absorbing layer which can be waterproof, this can further improve the light-blocking performance while avoiding the possibility of water damaging the light-absorbing layer.

FIG. 21 is a perspective view showing a dripper pop out the covering structure 265 and pass through the reserved hole 263. As shown in the figure, the user only needs to push the covering structure 265 with the additional dripper or stake, and after the covering structure 265 pops out from the reserved hole 263, the additional dripper or stake can pass through the reserved hole 263 and install in it.

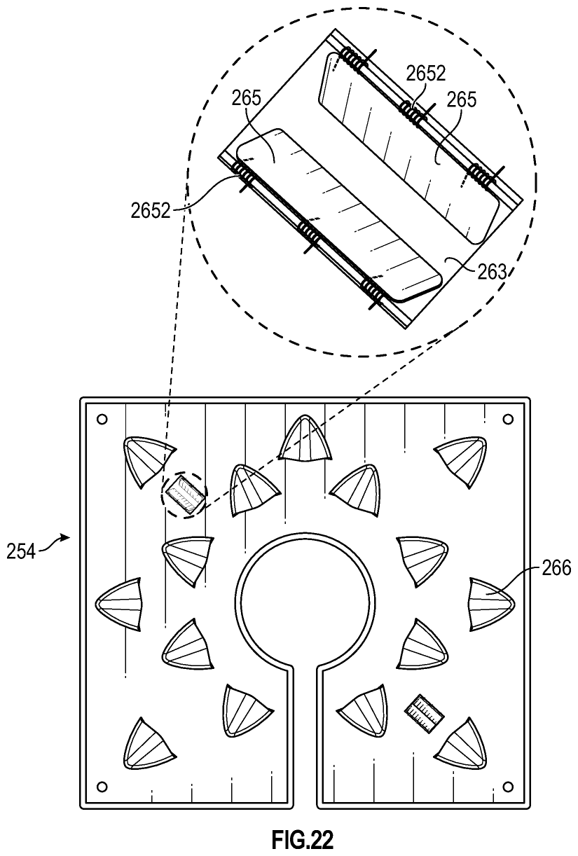

FIG. 22 is a top view of another embodiment of an irrigation apparatus, according to the present disclosure. As shown in the figure, compared with the previous embodiment, this embodiment has a different design in the installation and use of the covering structures 265. Here, the covering structures 265 of the present invention are pivotally connected to each of the reserved holes 263, and the covering structures 265 can be pushed to make the reserved holes 263 open to insert additional drippers or additional stakes through the reserved holes 263 while needed, and when pushing force disappears, the covering structures 265 return to original positions. In detail, each of the covering structures 265 comprises a spring 2652 to make the covering structure 265 able to return to the original position when the force disappears.

Through this approach, covering structures 265 can still cover the reserved holes 263 after the additional dripper or stake is taken out, and continue to block the light to prevent the soil from being exposed to light. Moreover, in this embodiment, each reserved hole 263 has two covering structures 265, but it can also be one covering structure 265, so it is not limited to this embodiment.

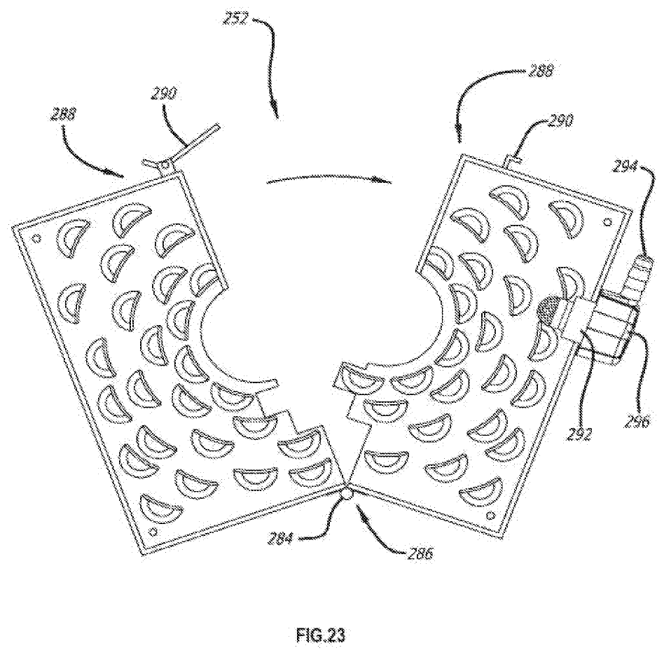

FIG. 23 is an enlarged top view of another exemplary embodiment of the irrigation apparatus 252 according to the present disclosure. The container 254 is configured with at least one hinge 284 or other suitable movable mechanism at a first end 286 such that the container is opened and closed at a second end 288 along with at least one of a clip or clamp 290 or via one male to one female ratio or other combinations of male to female ratios.

The irrigation apparatus can be filled with liquid by the user pouring in liquid directly into the container or setting a hose end into the container so that the liquid may fill the container. In some embodiments, the outer wall 256 of the container 254 may be optionally configured with an adapter 292 connectable to a variable size nozzle 294 via a thread cap 296 for use with a hose or pump system. FIG. 24A is a top perspective view of an exemplary embodiment of an irrigation apparatus 298 geometrically shaped as a circle according to the present disclosure. This embodiment is the same as that previously disclosed in FIGS. 17-18 with the addition of a further structural feature described below. The irrigation apparatus 298 includes a geometrically shaped container 300 of variable size having an outer wall 302 with an inner surface 304, an open top 306, and a base portion 308 configured to cover the plant growing medium. The base portion 308 is configured with a plurality of holes 310 (one shown covered with a dripper 320 and the other with a holed dripper cap 332) for receiving liquid therethrough.

As with the previous embodiments described herein, the container 300 is configured with at least one center opening 312 therethrough having an inner wall 314 for receiving a plant. The at least one center opening 312 has at least one longitudinal opening 316 extending therefrom to the outer wall 302 to allow placement of the container 300 on the plant or to allow removal of the container from the plant. In this embodiment, the container 300 is configured to bend to fit around the base of variable size plants. The at least one longitudinal opening 316 is configured to have the same height wall as the outer wall 302 of the container 300 while receding to a variable degree to the inner wall 314 of the at least one center opening 312. It should be understood that the at least one center opening can be configured of any suitable size and is sized relative to the size of the container.

In some embodiments, the at least one longitudinal opening 316 is configured with an overhang lip portion 318 at opposing sides for blocking light to the plant growing medium. It should be understood that the overhang lip portion can be configured of any suitable material, shape, and 30 size for blocking light to the plant growing medium.

The plurality of holes 310 are configured with at least one dripper 320 for receiving liquid extending therethrough the base portion 308 such that the at least one dripper feeds the plant growing medium at variable flow rates and intervals and provides stability for the apparatus 298 to be secured in the plant growing medium. It should be understood that the dripper may be configured to feed the plant growing medium at any suitable flow rate and interval in accordance with the present disclosure.

As illustrated in FIG. 24A, the container 300 may be configured with an overhang lip portion 322 formed around a top edge 324 of the outer wall 302 for blocking light to the plant growing medium. In some embodiments, the overhang lip portion 322 is configured with a plurality of geometrically shaped louvers 326 of variable size for blocking light to the plant growing medium while allowing air to pass through. It should be understood that the geometrically shaped louvers can be configured of any suitable size and are sized relative to the size of the overhang lip portion.

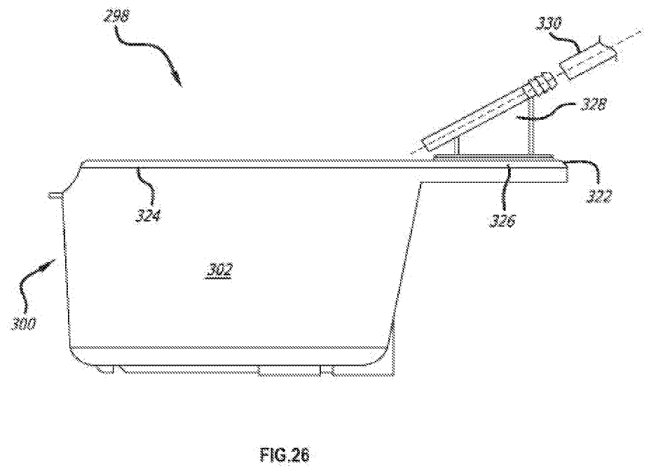

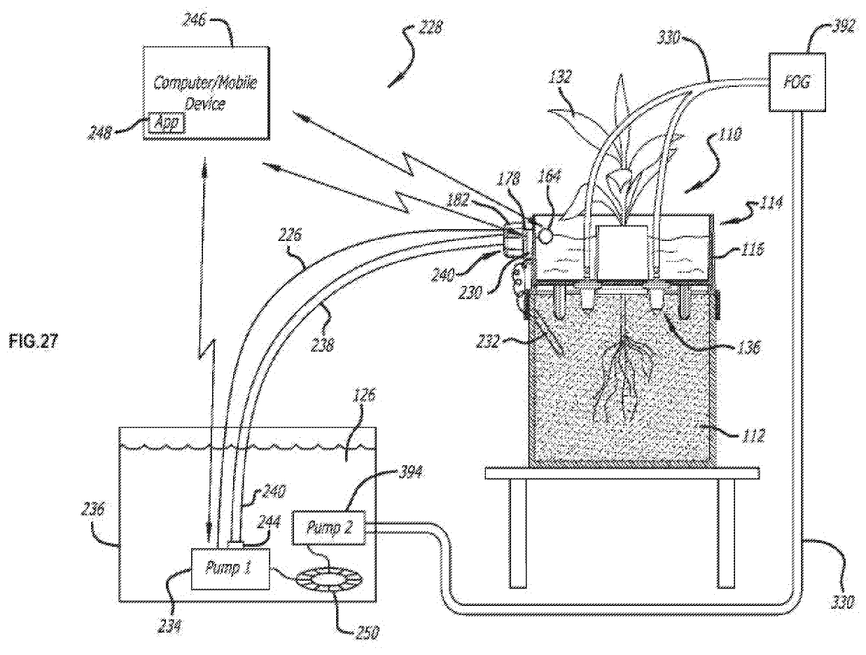

In further embodiments, the plurality of geometrically shaped louvers 326 may be configured to receive at least one barbed louver insert 328 for providing compatibility of the apparatus 298 for use with an irrigation feeding system (FIG. 27) such that the barbed louver insert is configured to connect to a hose 330 (FIG. 26). It should be understood that the barbed louver insert can be configured of any suitable size and is sized relative to the size of the geometrically shaped louvers 326. The barbed louver insert can be fabricated from any suitable sturdy material, such as plastic (e.g., acrylonitrile butadiene styrene (ABS)), synthetic polymers (e.g., nylon) and the like, and can be injection molded as a single piece.

FIG. 24B is a partial bottom perspective view of the irrigation apparatus 298 of FIG. 24A according to the present disclosure.

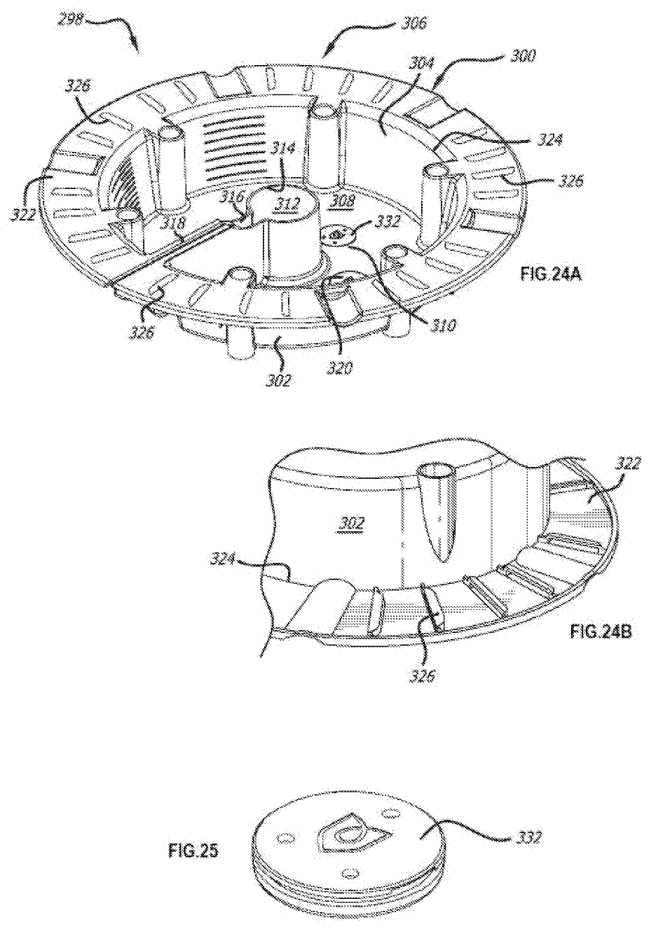

In some embodiments, the plurality of holes may be configured to receive at least one plug or dripper cap 332 (FIG. 25) having at least one hole for receiving liquid therethrough. The holed plug or dripper cap 332 is not contemplated for use with any dripper or emitter affixed thereto as gravity slows the pressure of the liquid during operation as liquid passes through the holed plug or dripper cap 332. As with the previously disclosed embodiments described herein, the plurality of holes 310 not in use may be sealed with a plug. It should be understood that the plug or dripper cap 332 and plug can be fabricated of any suitable material, such as rubber or plastic, and are sized relative to the size of the plurality of holes.

FIG. 27 is a side elevational view of an exemplary embodiment of the irrigation feeding system of FIG. 19 with a pressured fogger 392 according to the present disclosure. It should be understood that any of the drippers or emitters previously disclosed herein can be used with a pressured fogger or humidifier via a pump 394 in which fog or humidity is pumped through the hose 330 and into the dripper or emitter 136 within the plant growing medium of the irrigation feeding system 228. Any suitable fogger or humidifier can be used in accordance with the irrigation feeding system of the present disclosure.

Several of the features and functions disclosed above may be combined into different systems or applications, or combinations of systems and applications. Various presently unforeseen or unanticipated alternatives, modifications, variations or improvements therein may be subsequently made by those skilled in the art, each of which is also intended to be encompassed by the following claims.

1. An irrigation apparatus for dispersing liquid through a plant growing medium, the apparatus comprising:
a geometrically shaped container of variable size having an outer wall with an inner surface, an open top, and a base portion configured to cover the plant growing medium, wherein the base portion is configured with a plurality of holes for receiving liquid therethrough;
the container being configured with at least one center opening therethrough having an inner wall for receiving a plant, the at least one center opening having at least one longitudinal opening extending therefrom to the outer wall to all ow placement of the container on the plant or to allow removal of the container from the plant;
wherein the container is configured with a plurality of geometrically shaped stakes of variable size extending therefrom the base portion for providing stability for the apparatus to be secured in the plant growing medium;
wherein the container is configured with a plurality of reserved holes, and there is a covering structure connected to each of the reserved holes, and the covering structures can be removed from the reserved holes to insert additional drippers or additional stakes through the reserved holes while needed;
wherein a plurality of raised shields is formed and extended upward from the edge of the plurality of holes to block light and receive air, water, and nutrients, for the plant growing medium.

2. The apparatus of claim 1, wherein the plurality of holes is configured as louver structures, so that the raised shields and the louver structures will work together to block light and receive air, water, and nutrients, for the plant growing medium.

3. The apparatus of claim 2, wherein an angle set between a first direction of an opening of the raised shields which faces outward and a second direction of each channel of the louver structures which faces the plant growing medium, and the angle is around 30 degrees to 60 degrees.

4. The apparatus of claim 1, wherein each corner of the base portion is configured with a hole to aid in the drainage of liquid from the container.

5. The apparatus of claim 1, wherein the outer wall of the container may be optionally configured with an adapter connectable to a variable size nozzle via a thread cap for use with a hose or pump system.

6. The apparatus of claim 1, wherein the covering structure is connected to each of the reserved holes through a plurality of gates, and while removing the covering structures, external force will be applied to the covering structures, then the gates will be broken, causing the covering structures to pop out from the reserved holes.

7. The apparatus of claim 6, wherein type of the gates are selected from one of following: edge gate, tab gate, film gate, or submarine gate

8. The apparatus of claim 1, wherein the container may be fabricated of a combination of translucent and opaque materials as separate parts or as an over mold that can be molded together such that the outer wall is translucent and the base portion is opaque for blocking light to the plant growing medium.

9. The apparatus of claim 1, wherein the at least one longitudinal opening is configured with an overhang lip portion at opposing sides for blocking light to the plant growing medium.

10. An irrigation apparatus for dispersing liquid through a plant growing medium, the apparatus comprising:
a geometrically shaped container of a variable size having a wall with an inner surface, an open top, and a base portion configured cover the plant growing medium wherein the base portion is configured with a plurality of holes receiving liquid therethrough;
wherein the container is being configured with at least one center opening therethrough having an inner wall receiving a plant, the at least one center opening having at least one longitudinal opening extending therefrom to the outer wall to allow placement of the container on the plant or allow removal the container from the plant;
wherein the container is configured with a plurality of geometrically shaped stakes of variable sizes extending therefrom the base portion providing stability for the apparatus to be secured in the plant growing medium;
wherein the container is configured with a plurality of reserved holes, and there is a covering structure pivotally connected to each of the reserved holes, and the covering structures can be pushed to make the reserved holes open to insert additional drippers or additional stakes through the reserved holes while needed, and when pushing force disappears, the covering structures return to original positions;
wherein the outer wall of the container is translucent and the base portion is opaque;
wherein a plurality of raised shields is formed and extended upward from the edge of the plurality of holes to block light and receive air, water, and nutrients, for the plant growing medium.

11. The apparatus of claim 10, wherein each corner of the base portion is configured with a hole to aid in the drainage of liquid from the container.

12. The apparatus of claim 10, wherein each of the covering structures comprises a spring to make the covering structure able to return to the original position when the force disappears.

13. The apparatus of claim 10, wherein the plurality of holes is configured as louver structures, so that the raised shields and the louver structures will work together to block light and receive air, water, and nutrients, for the plant growing medium.

14. The apparatus of claim 13, wherein an angle set between a first direction of an opening of the raised shields which faces outward and a second direction of each channel of the louver structures which faces the plant growing medium, and the angle is around 30 degrees to 60 degrees.

15. An irrigation apparatus for dispersing liquid through a plant growing medium, the apparatus comprising:
a geometrically shaped container of a variable size having ail outer wall with an inner surface, an open top, and a base portion configured to cover the plant growing medium, wherein the base portion is configured with a plurality of holes for receiving liquid therethrough, each corner of the base portion configured with a hole to aid in the drainage of liquid from the container;
wherein the container is being configured with at least one center opening therethrough having an inner wall for receiving a plant, the at least one center opening having at least one longitudinal opening extending therefrom to the outer wall to allow placement of the container on the plant or to allow removal of the container from the plant; and wherein the container is configured with a plurality of geometrically shaped stakes of variable sizes extending therefrom the base portion for providing stability for the apparatus to be secured in the plant growing medium;
wherein the container is configured with a plurality of reserved holes, and there is a covering structure connected to each of the reserved holes, and the covering structures can be removed from the reserved holes to insert additional drippers or additional stakes through the reserved holes while needed;
wherein the outer wall of the container is translucent, and the base portion is opaque;
wherein a plurality of raised shields is formed and extended upward from the edge of the plurality of holes, and the plurality of holes is configured as louver structures, so that the raised shields and the louver structures will work together to block light and receive air, water, and nutrients, for the plant growing medium.

16. The apparatus of claim 15, wherein the at least one longitudinal opening is defined by approximately the same height wall as the outer wall of the container while receding to a variable degree to the inner wall of the at least one center opening.

17. The apparatus of claim 15, wherein the at least one longitudinal opening comprises an overhang lip portion at opposing sides.

18. The apparatus of claim 15, wherein an angle set between a first direction of an opening of the raised shields which faces outward and a second direction of each channel of the louver structures which faces the plant growing medium, and the angle is around 30 degrees to 60 degrees.

19. (canceled)
